(19) United States
(12) Patent Application Publication
(10) Pub. No.: US 2025/0256347 A1
(43) Pub. Date: Aug. 14, 2025

(54) RESISTANCE SPOT WELDING METHOD

(71) Applicants: Shuhei OGURA, Toyota-shi, Aichi (JP); Tomohiko SEKIGUCHI, Toyota-shi, Aichi (JP); Kyosuke IZUNO, Toyota-shi, Aichi (JP); Yosuke TAMADA, Toyota-shi, Aichi (JP); Takahiro FUKAYA, Anjo-shi, Aichi (JP); TOYOTA JIDOSHA KABUSHIKI KAISHA, Toyota-shi, Aichi (JP); TOYOTOMI KIKO CO., LTD., Anjo-shi, Aichi (JP)

(72) Inventors: Shuhei OGURA, Nagakute-shi (JP); Tomohiko SEKIGUCHI, Nagakute-shi (JP); Kyosuke IZUNO, Nisshin-shi (JP); Yosuke TAMADA, Toyota-shi (JP); Takahiro FUKAYA, Okazaki-shi (JP)

(73) Assignees: TOYOTA JIDOSHA KABUSHIKI KAISHA, Toyota-shi, Aichi (JP); TOYOTOMI KIKO CO., LTD., Anjo-shi, Aichi (JP)

(21) Appl. No.: 18/867,195

(22) PCT Filed: May 23, 2023
(86) PCT No.: PCT/JP2023/019054

§ 371 Date: Nov. 19, 2024

(30) Foreign Application Priority Data
May 24, 2022 (JP) 2022-084349

(51) Int. Cl. B23K 11/11

(52) U.S. Cl. CPC B23K 11/115

(57) ABSTRACT

Provided is a resistance spot welding method capable of efficiently generating a nugget that is as large as possible while reducing the occurrence of spatter. The resistance spot welding method includes: placing on top of one another at least two steel plates including a plating layer of zinc as a main component or an Al—Si plating layer; sandwiching the at least two steel plates between a pair of electrodes; and performing preliminary current application between the pair of electrodes and then performing main current application. The resistance spot welding method performs the preliminary current application so as to include a current application pattern in which a current value of a welding current at a current application start time of the preliminary current application is set as a maximum value, and the current value sequentially decreases stepwise from the maximum value.

### TECHNICAL FIELD

The present disclosure relates to a resistance spot welding method.

### BACKGROUND ART

In resistance spot welding, it is known to perform current application of the welding current between electrodes in separate periods, that is, a main current application period and a preliminary current application period (also referred to as initial current application) that precedes the main current application period.

Patent Literature 1 discloses a resistance spot welding method in which the preliminary current application period includes two-step current application, where a current value I1 in a first step of current application is set to a range satisfying Im×1.1≤I1≤15.0 kA, with respect to a current value Im during the main current application period, and a current value I2 in a second step of current application is set to no current application or low current application satisfying 0≤I2≤Im×0.7.

### CITATION LIST

### Patent Literature

Patent Literature 1: WO 2015/083381

### SUMMARY OF INVENTION

### Technical Problem

However, in the welding method disclosed in Patent Literature 1, due to the long current application time in a pulsation form, a nugget is generated during the current application in the pulsation form, causing a poor ratio between an alloy layer diameter and a nugget diameter. In particular, when it is presumed to perform welding under a welding pressure of 4 kN or lower, which allows welding with a compact welding gun, the nugget grows rapidly during the current application in the pulsation form, and spatter occurs. Additionally, in the welding method disclosed in Patent Literature 1, since the electric current rapidly increases during the main current application period, it is difficult to increase the likelihood of spatter during the main current application period.

The present disclosure has been made in view of the foregoing, and provides a resistance spot welding method capable of efficiently generating a nugget that is as large as possible while reducing the occurrence of spatter.

### Solution to Problem

To solve the above-described issue, the resistance spot welding method of the present disclosure includes: placing on top of one another at least two steel plates including a plating layer of zinc as a main component or an Al—Si plating layer; sandwiching the at least two steel plates between a pair of electrodes; and performing preliminary current application between the pair of electrodes and then performing main current application, such that the steel plates that are adjacent to each other are melted and joined together. The resistance spot welding method performs the preliminary current application so as to include a current application pattern in which a current value of a welding current at a current application start time of the preliminary current application is set as a maximum value, and the current value sequentially decreases stepwise from the maximum value along with a lapse of a current application time from the current application start time.

As described above, the resistance spot welding method of the present disclosure allows the welding current of the maximum current value to flow at the current application start time of the preliminary current application, at which time the steel plates are rigid, and the contact area between the steel plates and the pair of electrodes and the contact area between the adjacent steel plates are small. This can increase the temperature of the welding portion in a short time at the current application start time of the preliminary current application. In addition, the resistance spot welding method of the present disclosure finely controls the current value such that the current value of the welding current sequentially decreases stepwise from the maximum value. This can efficiently generate the alloy layer and the nugget at an early stage of the preliminary current application while efficiently increasing the temperature of the welding portion, and can reduce the occurrence of spatter by expanding the nugget diameter according to the expansion of the alloy layer diameter. Accordingly, the resistance spot welding method of the present disclosure can efficiently generate the nugget that is as large as possible while reducing the occurrence of spatter.

### Advantageous Effects of Invention

According to the present disclosure, it is possible to provide a resistance spot welding method capable of efficiently generating a nugget that is as large as possible while reducing the occurrence of spatter.

### BRIEF DESCRIPTION OF DRAWINGS

FIG. 1 is a diagram describing a resistance spot welding device for performing a resistance spot welding method of the present embodiment.

FIG. 2 is a cross-sectional diagram schematically illustrating a state where a plurality of steel plates is sandwiched between a pair of electrodes.

FIG. 3 is a cross-sectional diagram illustrating a state where the plurality of steel plates illustrated in FIG. 2 is joined together.

FIG. 4 includes diagrams illustrating exemplary current application patterns of the present embodiment and a comparative example.

FIG. 5 is a diagram illustrating a current application time required for the ratio of an alloy layer diameter to a nugget diameter to reach 1.2 in the current application patterns of the present embodiment and the comparative example.

FIG. 6 is a diagram illustrating transition of the alloy layer diameter and the nugget diameter of the alloy layer and the nugget generated in the boundary portion between the second steel plate and the third steel plate illustrated in FIG. 2.

FIG. 7 includes cross-sectional diagrams illustrating a state of the alloy layer and the nugget generated by the current application patterns of the present embodiment and the comparative example.

FIG. 8 is a diagram illustrating transition of the nugget diameter of the nugget generated in the boundary portion between the first steel plate and the second steel plate illustrated in FIG. 2.

FIG. 9 is a cross-sectional diagram schematically illustrating a state where a plurality of steel plates having a different aspect from FIG. 2 is sandwiched between a pair of electrodes.

FIG. 10 is a diagram illustrating transition of the alloy layer diameter and the nugget diameter of the alloy layer and the nugget generated in the boundary portion between the first steel plate and the second steel plate illustrated in FIG. 9.

FIG. 11 is a diagram illustrating transition of the nugget diameter of the nugget generated in the boundary portion between the second steel plate and the third steel plate illustrated in FIG. 9.

### DESCRIPTION OF EMBODIMENTS

Hereinafter, embodiments of the present disclosure will be described with reference to the drawings. In each embodiment, unless otherwise specified, elements denoted by identical reference signs have similar functions in each embodiment, and description thereof will be omitted.

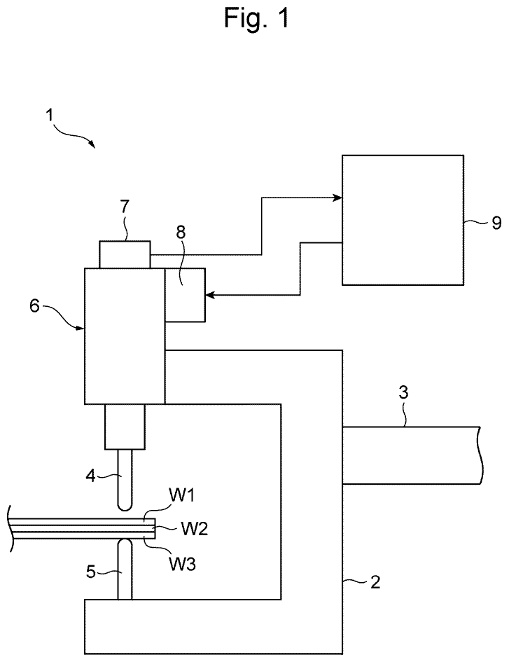

FIG. 1 is a diagram describing a resistance spot welding device 1 for performing a resistance spot welding method of the present embodiment.

The resistance spot welding device 1 includes a welding gun 2 held by a robot arm 3, and a pair of electrodes 4, 5 attached to the welding gun 2. The pair of electrodes 4, 5 is made up of an upper electrode 4 and a lower electrode 5. Further, the resistance spot welding device 1 includes an elevator 6 configured to move the upper electrode 4 up and down, a position detecting device 7 configured to detect a position of the pair of electrodes 4, 5, and a current adjusting device 8 configured to adjust a current value of a welding current allowed to flow between the pair of electrodes 4, 5. Further, the resistance spot welding device 1 includes a control device 9 configured to control the elements of the resistance spot welding device 1 to control the position of the pair of electrodes 4, 5, the welding pressure applied to a welding target, and the current value of the welding current.

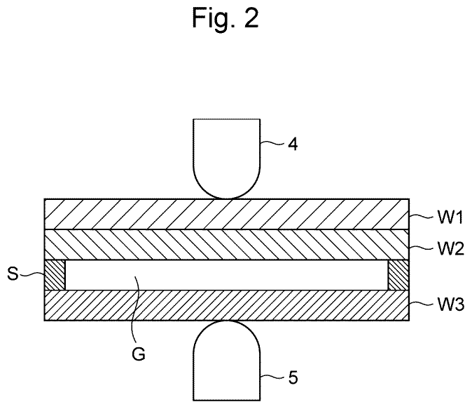

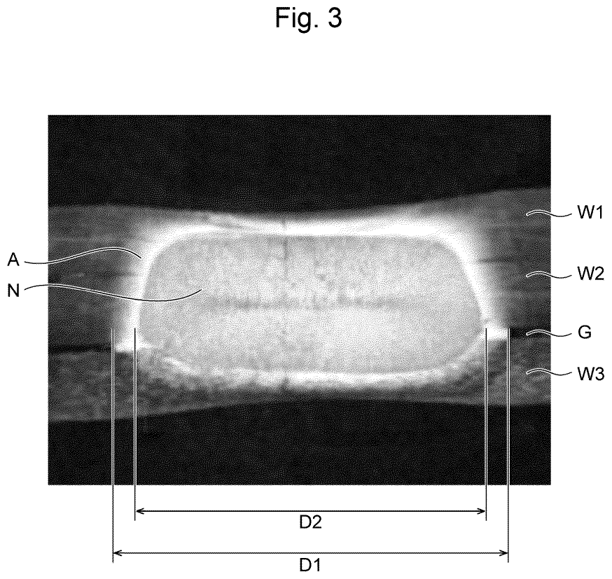

With reference to FIG. 2 to FIG. 3, a welding target of the resistance spot welding method of the present embodiment will be described. FIG. 2 is a cross-sectional diagram schematically illustrating a state where a plurality of steel plates is sandwiched between the pair of electrodes 4, 5. FIG. 3 is a cross-sectional diagram illustrating a state where the plurality of steel plates illustrated in FIG. 2 is joined together.

In the resistance spot welding method of the present embodiment, the welding target is a stack of steel plates obtained by placing on top of one another at least two steel plates including a plating layer of zinc as a main component. In the present embodiment, the stack of steel plates includes a first steel plate W1, a second steel plate W2, and a third steel plate W3 placed on top of one another. The first steel plate W1 and the second steel plate W2 may be SCGA1180, for example. The third steel plate W3 may be SCGA440, for example. The first steel plate W1 and the second steel plate W2 have a rigidity of the steel plate different from that of the third steel plate W3. The first steel plate W1 to the third steel plate W3 may each have a thickness of 1.4 mm, for example.

In addition, in the present embodiment, on the assumption that there is a plate gap in the boundary portion between the adjacent steel plates, a gap G simulating the plate gap is provided. The gap G is provided by placing a shim S with a height of 2 mm between the second steel plate W2 and the third steel plate W3, for example.

The resistance spot welding method of the present embodiment allows the welding current to flow between the pair of electrodes 4, 5 in a state where the plurality of steel plates as illustrated in FIG. 2 is sandwiched between and pressurized by the pair of electrodes 4, 5, such that the adjacent steel plates are melted and joined together. As illustrated in FIG. 3, in the plurality of steel plates joined together, a nugget N and an alloy layer A surrounding the periphery of the nugget N are generated. The nugget N is generated when iron of the base material of each steel plate is melted and then solidifies. The alloy layer A is generated when zinc of the plating layer of each steel plate and iron of the base material of each steel plate react with each other at high temperature. An alloy layer diameter D1 is an outer dimension of the alloy layer A in a direction along each steel plate. A nugget diameter D2 is an outer dimension of the nugget N in a direction along each steel plate.

In the resistance spot welding method of the present embodiment, when the welding current is allowed to flow between the pair of electrodes 4, 5, preliminary current application is performed prior to main current application, and the main current application is performed after the preliminary current application. The inventors of the present application have conducted intensive studies in an attempt to determine what current application pattern should be employed as the current application pattern that is a control pattern of the current value of the welding current in the preliminary current application and the main current application, and then created a current application pattern that efficiently generates a nugget that is as large as possible while reducing the occurrence of spatter. The current application pattern indicates how the current value of the welding current should be changed along with a lapse of a current application time. Note that the welding conditions except for the current application pattern may be similar to the conventional welding conditions.

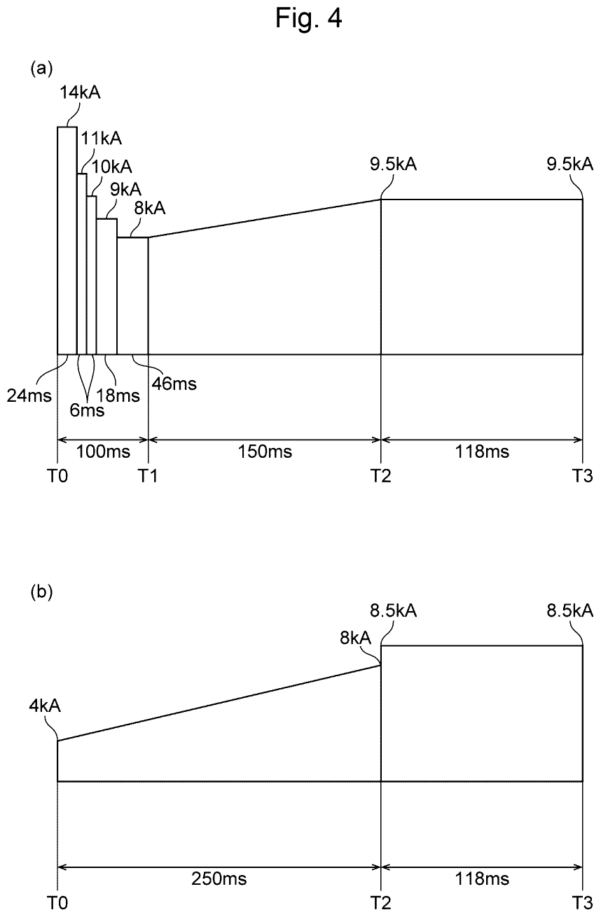

With reference to FIG. 4 to FIG. 8, the current application pattern of the welding current in the resistance spot welding method of the present embodiment will be described. FIG. 4(a) is a diagram illustrating an exemplary current application pattern of the present embodiment. FIG. 4(b) is a diagram illustrating an exemplary current application pattern of the comparative example.

In FIG. 4(a) and FIG. 4(b), a point in time T0 indicates a point in time when current application starts. A point in time T1 indicates a point in time when 100 ms has elapsed since the point in time T0. A point in time T2 indicates a point in time when 150 ms has elapsed since the point in time T1. A point in time T3 indicates a point in time when 118 ms has elapsed since the point in time T2. The period from the point in time T0 to the point in time T2 indicates a preliminary current application period. The period from the point in time T2 to the point in time T3 indicates a main current application period.

In the current application pattern of the present embodiment, as illustrated in FIG. 4(a), different current application patterns are employed in a first period starting from the current application start time of the preliminary current application and a second period starting after the first period. That is, the first period of the preliminary current application from the point in time T0 to the point in time T1 employs a current application pattern in which the current value of the welding current at the current application start time (the point in time T0) of the preliminary current application is set as a maximum value, and the current value sequentially decreases stepwise from the maximum value along with a lapse of the current application time from the current application start time. The second period of the preliminary current application from the point in time T1 to the point in time T2 employs an upslope current application pattern in which the current value gradually increases from the current value at the first period end time (the point in time T1) along with a lapse of the current application time. The main current application period from the point in time T2 to the point in time T3 employs a current application pattern in which the current value is constant from the second period end time (the point in time T2) of the preliminary current application to the main current application period end time (the point in time T3).

The stepwise current application pattern employed in the first period of the preliminary current application is composed of multiple combinations of the current value of the welding current and the current application time for the current value. The current values, the current application time for each of the current values, and the number of the current values (the number of steps) forming the stepwise current application pattern employed in the first period of the preliminary current application may vary depending on the type of steel plate to be welded and the method of assembling the steel plates, and may be determined in advance by experiments or the like.

In the example illustrated in FIG. 4(a), the stepwise current application pattern employed in the first period of the preliminary current application is the following current application pattern. That is, in the stepwise current application pattern illustrated in FIG. 4(a), current application of a first current value (14 kA) indicating the maximum current value of the welding current is continued for a first current application time (24 ms) from the current application start time of the preliminary current application. In the stepwise current application pattern illustrated in FIG. 4(a), current application of a second current value (11 kA) smaller than the first current value is continued for a second current application time (6 ms) from the point in time when the first current application time has elapsed. In the stepwise current application pattern illustrated in FIG. 4(a), current application of a third current value (10 kA) smaller than the second current value is continued for a third current application time (6 ms) from the point in time when the second current application time has elapsed. In the stepwise current application pattern illustrated in FIG. 4(a), current application of a fourth current value (9 kA) smaller than the third current value is continued for a fourth current application time (18 ms) from the point in time when the third current application time has elapsed. In the stepwise current application pattern illustrated in FIG. 4(a), current application of a fifth current value (8 kA) smaller than the fourth current value is continued for a fifth current application time (46 ms) from the point in time when the fourth current application time has elapsed.

Each of the combinations of the current value and the current application time for the current value forming the stepwise current application pattern employed in the first period of the preliminary current application is a combination of an upper limit current value (spatter limit current value) that can reduce occurrence of spatter and an upper limit current application time that can reduce occurrence of spatter during current application of the upper limit current value. In other words, the point in time when each of the current values forming the stepwise current application pattern employed in the first period of the preliminary current application shifts to the next current value corresponds to the point in time immediately before spatter occurs by the current application of each of the current values.

The combination of the upper limit current value and the upper limit current application time that can reduce the occurrence of spatter is, specifically, a combination in which the ratio (D1/D2) of the alloy layer diameter D1 to the nugget diameter D2 has a value equal to or larger than a reference value (a value in a range of 1.2 to 1.5) set in advance. This reference value will be described later.

In the example illustrated in FIG. 4(a), the combination of the first current value and the first current application time is a combination of the upper limit current value that can reduce the occurrence of spatter even by the current application of the first current value and the upper limit current application time that can reduce the occurrence of spatter even by the continuation of the current application of the first current value for the first current application time. The same also applies to the combination of the second current value and the second current application time, the combination of the third current value and the third current application time, the combination of the fourth current value and the fourth current application time, and the combination of the fifth current value and the fifth current application time.

In contrast, in the current application pattern of the comparative example, as illustrated in FIG. 4(b), the preliminary current application period from the point in time T0 to the point in time T2 employs an upslope current application pattern in which the current value gradually increases from the current value of the welding current at the current application start time (the point in time T0) of the preliminary current application along with a lapse of the current application time. The main current application period from the point in time T2 to the point in time T3 employs a current application pattern in which the constant current value is maintained from the main current application period start time (the point in time T2) to the main current application period end time (the point in time T3). However, as illustrated in FIG. 4(b), the constant current value maintained in the main current application period is a value larger than the maximum current value in the preliminary current application period.

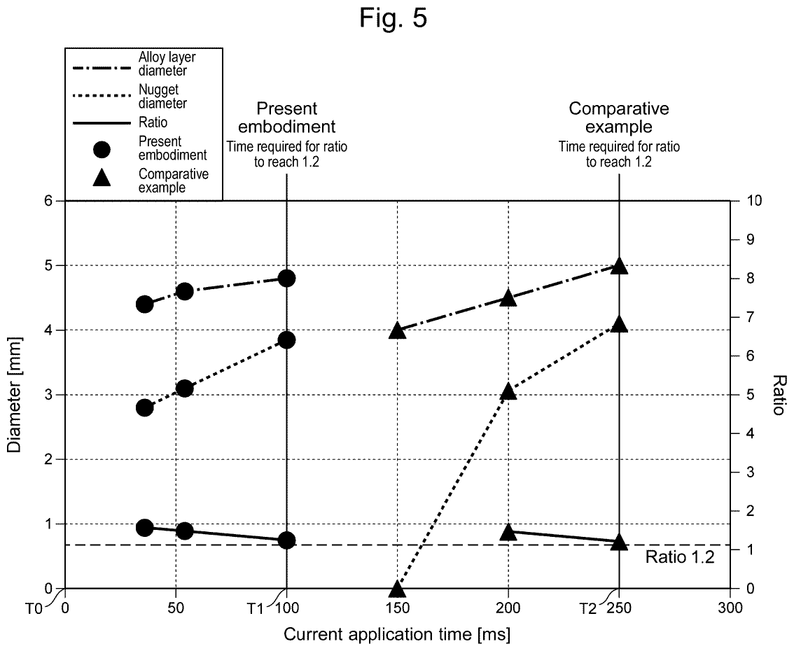

FIG. 5 is a diagram illustrating a current application time required for the ratio (D1/D2) of the alloy layer diameter D1 to the nugget diameter D2 to reach the reference value=1.2 in the current application patterns of the present embodiment and the comparative example.

Spatter is less likely to occur in a state where the nugget N is surrounded by the alloy layer A, but tends to occur when the nugget N is exposed from the alloy layer A. That is, the alloy layer A serves as a dam for reducing the occurrence of spatter. When the ratio of the alloy layer diameter D1 to the nugget diameter D2 is below the reference value=1.2 set in advance, the nugget N is exposed from the alloy layer A and spatter tends to occur. When the ratio of the alloy layer diameter D1 to the nugget diameter D2 is equal to the reference value=1.2, the nugget N can maintain the state of being surrounded by the alloy layer A, and the occurrence of spatter can be reduced.

In addition, when the ratio of the alloy layer diameter D1 to the nugget diameter D2 is larger than the reference value=1.2, there is a room large enough to expand the nugget N. In this case, the amount of heat input to the welding portion (the boundary portion between the adjacent steel plates) is not sufficient, causing unnecessary consumption of the current application time with reference to the intention to cause the nugget N to grow as much as possible while reducing the occurrence of spatter. This means that, in this case, the current application is inefficient.

In view of the foregoing, it can be deemed that when the current application time required for the ratio of the alloy layer diameter D1 to the nugget diameter D2 to reach the reference value=1.2 is short, it is possible to efficiently generate the nugget N that is as large as possible while reducing the occurrence of spatter.

That is, the reference value regarding the ratio of the alloy layer diameter D1 to the nugget diameter D2 indicates a value of the ratio for distinction of whether the reduction of the occurrence of spatter and the efficient generation of the nugget N can be achieved at the same time. This reference value may vary depending on the type of steel plate to be welded and the method of assembling the steel plates, and may be determined in advance by experiments or the like. The inventors of the present application have conducted intensive studies in an attempt to obtain an optimal value of the reference value for various types of steel plate to be welded and various methods of assembling the steel plates, and then found that the reference value can be set as a predetermined value included in the range of 1.2 to 1.5. The reference value=1.2 is set for the type of steel plate and the method of assembling the steel plates illustrated in FIG. 2. However, the reference value is not limited thereto in the resistance spot welding method of the present embodiment, and the reference value may be set as a predetermined value included in the range of 1.2 to 1.5 depending on the type of steel plate to be welded and the method of assembling the steel plates.

As illustrated in FIG. 5, in the current application pattern of the comparative example, the ratio of the alloy layer diameter D1 to the nugget diameter D2 reaches the reference value=1.2 at the preliminary current application period end time (the point in time T2), requiring a current application time of 250 ms. This is because the current application pattern of the comparative example is directed to surely reducing the occurrence of spatter by generating the alloy layer A having a certain degree of size prior to generating the nugget N.

Meanwhile, in the current application pattern of the present embodiment, the ratio of the alloy layer diameter D1 to the nugget diameter D2 reaches the reference value=1.2 at the first period end time (the point in time T1) of the preliminary current application, requiring only a current application time of 100 ms. That is, the current application pattern of the present embodiment requires only 40% of the current application time of the current application pattern of the comparative example. Further, like the current application pattern of the comparative example, the current application pattern of the present embodiment maintains the state where the alloy layer diameter D1 is sufficiently larger than the nugget diameter D2, and the nugget N is surrounded by the alloy layer A. Accordingly, since the preliminary current application of the present embodiment includes the current application pattern in which the current value sequentially decreases stepwise as in the first period, it can be found that the nugget N that is as large as possible can be generated in a shorter time than the comparative example while reducing the occurrence of spatter.

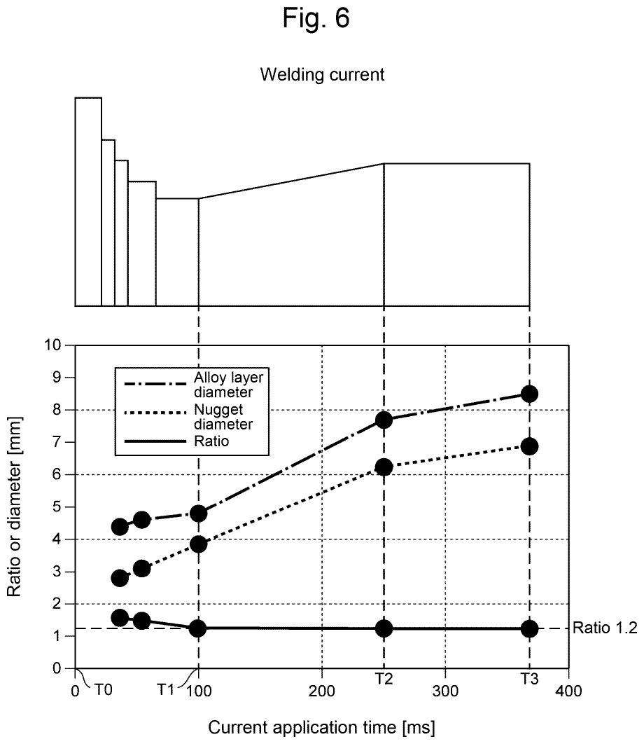

FIG. 6 is a diagram illustrating transition of the alloy layer diameter D1 and the nugget diameter D2 of the alloy layer A and the nugget N generated in the boundary portion between the second steel plate W2 and the third steel plate W3 illustrated in FIG. 2. That is, FIG. 6 illustrates transition of the alloy layer diameter D1 and the nugget diameter D2 when there is a plate gap in the boundary portion between the adjacent steel plates.

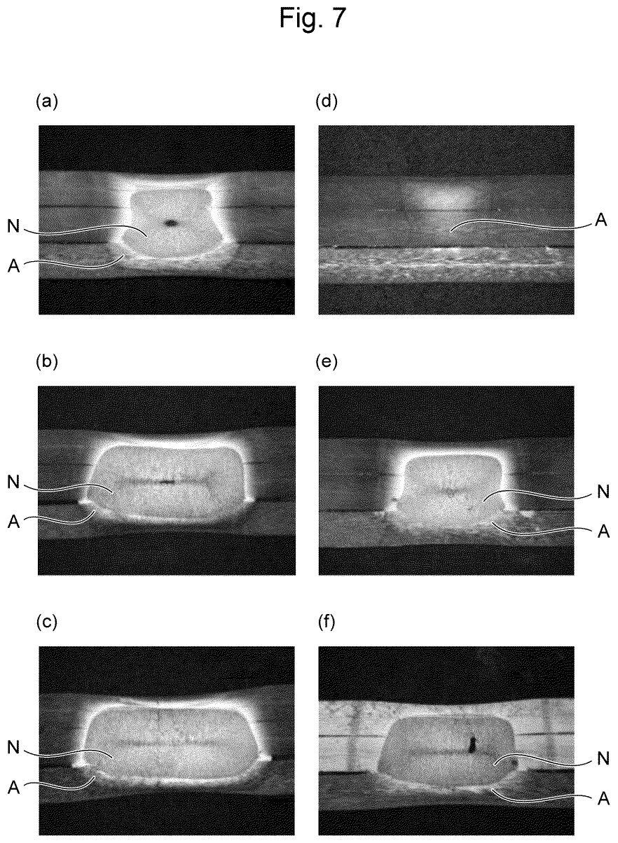

FIG. 7(a) to FIG. 7(c) are cross-sectional diagrams illustrating the state of the alloy layer A and the nugget N generated by the current application pattern of the present embodiment. FIG. 7(a) is a cross-sectional diagram illustrating the state of the alloy layer A and the nugget N at the first period end time (the point in time T1) of the preliminary current application. FIG. 7(b) is a cross-sectional diagram illustrating the state of the alloy layer A and the nugget N at the second period end time (the point in time T2) of the preliminary current application. FIG. 7(c) is a cross-sectional diagram illustrating the state of the alloy layer A and the nugget N at the main current application period end time (the point in time T3).

As illustrated in FIG. 6, in the current application pattern of the present embodiment, in the first period of the preliminary current application, even when there is a plate gap, the alloy layer diameter D1 and the nugget diameter D2 continue to expand with the alloy layer diameter D1 sufficiently larger than the nugget diameter D2. That is, the current application pattern of the present embodiment can generate the alloy layer A and the nugget N with the nugget N being surrounded by the alloy layer A while reducing the occurrence of spatter. At the current application start time (the point in time T0) of the preliminary current application, the steel plates are rigid, and the contact area between the steel plates and the pair of electrodes 4, 5 and the contact area between the adjacent steel plates are small, and thus the temperature of the welding portion is most likely to increase. Then, in the current application pattern of the present embodiment, the welding current of the maximum current value is allowed to flow at the current application start time of the preliminary current application, so as to increase the temperature of the welding portion in a short time. In addition, by finely controlling the current value such that the current value of the welding current sequentially decreases stepwise from the maximum value throughout the first period of the preliminary current application, the alloy layer A and the nugget N are efficiently generated while efficiently increasing the temperature of the welding portion, and the occurrence of spatter is reduced by expanding the nugget diameter D2 according to the expansion of the alloy layer diameter D1. In FIG. 7(a), it can be confirmed that the nugget N surrounded by the alloy layer A is generated at the first period end time (the point in time T1) of the preliminary current application.

Then, in the current application pattern of the present embodiment, in the second period of the preliminary current application, the alloy layer diameter D1 and the nugget diameter D2 continue to expand with the alloy layer diameter D1 sufficiently larger than the nugget diameter D2 by gradually increasing the current value of the welding current from first period end time (the point in time T1). In FIG. 7(b), it can be confirmed that at the second period end time (the point in time T2) of the preliminary current application, the alloy layer A and the nugget N have grown larger than those of FIG. 7(a), with the nugget N being surrounded by the alloy layer A.

Then, in the current application pattern of the present embodiment, in the main current application period, the alloy layer diameter D1 and the nugget diameter D2 continue to expand with the alloy layer diameter D1 sufficiently larger than the nugget diameter D2 by keeping the constant current value of the welding current from the second period end time (the point in time T2) of the preliminary current application. In FIG. 7(c), it can be confirmed that at the main current application period end time (the point in time T3), the alloy layer A and the nugget N have further grown larger than those of FIG. 7(b), with the nugget N being surrounded by the alloy layer A.

That is, in the current application pattern of the present embodiment, in the second period of the preliminary current application and the main current application period, it is possible to allow the alloy layer A and the nugget N to grow while reducing the occurrence of spatter. Additionally, as illustrated in FIG. 6, it is found that in the second period of the preliminary current application and the main current application period, the ratio of the alloy layer diameter D1 to the nugget diameter D2 can be maintained at the reference value=1.2. This is because by employing the above-described current application pattern in the second period of the preliminary current application and the main current application period, the amount of heat input to the welding portion at the spatter limit current value can be maximized to allow the alloy layer A and the nugget N to efficiently grow while suppressing the rapid increase in the temperature of the welding portion to reduce the occurrence of spatter. The spatter limit current value is a limit current value that can reduce the occurrence of spatter. When the welding current of the constant current value is applied without upslope current application as in the second period of the preliminary current application, it is difficult to control the growth of the nugget N since an excessively high current value causes the occurrence of spatter, whereas an excessively low current value causes reduction of the grow speed of the nugget N. When the welding current is applied in an upslope manner without the current application of the constant current value as in the main current application period, the growth of the nugget N can easily be controlled compared to the current application of the constant current value, but it is difficult to maximize the amount of heat input to the welding portion at the spatter limit current value.

In view of the above, in the current application pattern of the present embodiment, by employing the above-described current application pattern in the first period and the second period of the preliminary current application as well as in the main current application period, it is possible to efficiently generate the nugget N that is as large as possible while reducing the occurrence of spatter even when there is a plate gap.

FIG. 7(d) to FIG. 7(f) are cross-sectional diagrams illustrating the state of the alloy layer and the nugget generated by the current application pattern of the comparative example. FIG. 7(d) is a cross-sectional diagram illustrating the state of the alloy layer A and the nugget N at a point in time when a current application time of 100 ms has elapsed (the same point in time as the point in time T1). FIG. 7(e) is a cross-sectional diagram illustrating the state of the alloy layer A and the nugget N at the preliminary current application period end time (the point in time T2). FIG. 7(f) is a cross-sectional diagram illustrating the state of the alloy layer A and the nugget N at the main current application period end time (the point in time T3).

In the current application pattern of the comparative example, at the same point in time as the first period end time (the point in time T1) of the preliminary current application of the present embodiment, as illustrated in FIG. 7(d), it can be confirmed that although the alloy layer A is generated, the nugget N is not generated. In the current application pattern of the comparative example, at the preliminary current application period end time (the point in time T2), as illustrated in FIG. 7(e), it can be confirmed that although the nugget N surrounded by the alloy layer A is generated, the alloy layer A and the nugget N have a size that is smaller than that in FIG. 7(b). In the current application pattern of the comparative example, at the main current application period end time (the point in time T3), as illustrated in FIG. 7(f), it can be confirmed that although the state where the nugget N is surrounded by the alloy layer A is maintained, the alloy layer A and the nugget N have a size that is smaller than that in FIG. 7(c). That is, it can be confirmed that the current application pattern of the present embodiment can generate the nugget N that is larger than that of the comparative example.

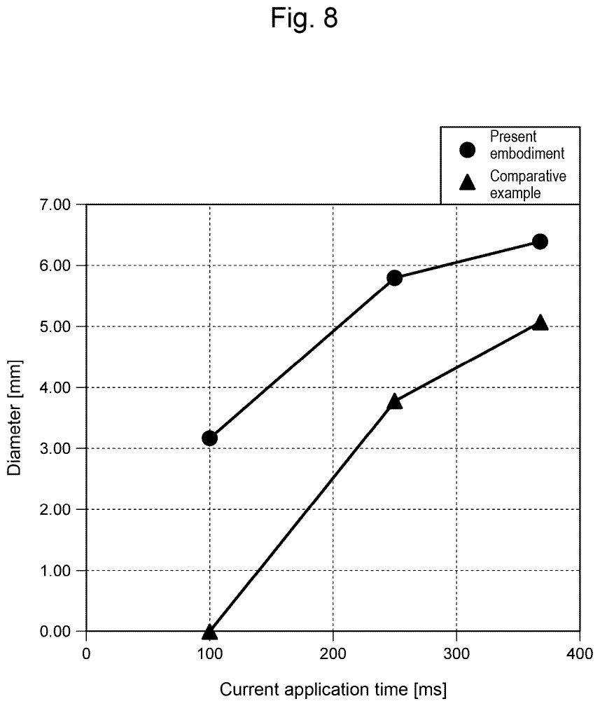

FIG. 8 is a diagram illustrating transition of the nugget diameter D2 of the nugget N generated in the boundary portion between the first steel plate W1 and the second steel plate W2 illustrated in FIG. 2.

FIG. 8 illustrates transition of the nugget diameter D2 when there is no plate gap in the boundary portion between the adjacent steel plates. As illustrated in FIG. 8, it is found that the current application pattern of the present embodiment can generate the nugget N that is larger than that of the comparative example not only in the boundary portion with a plate gap, but also in the boundary portion without a plate gap.

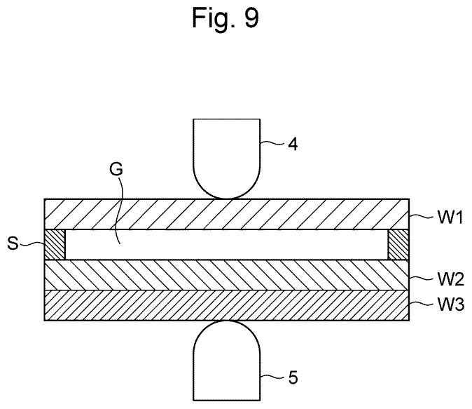

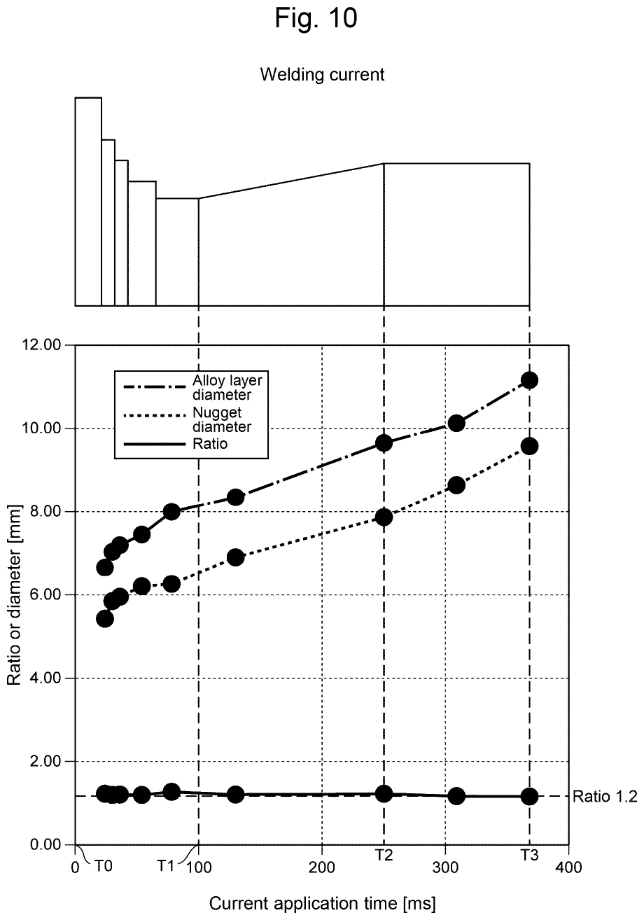

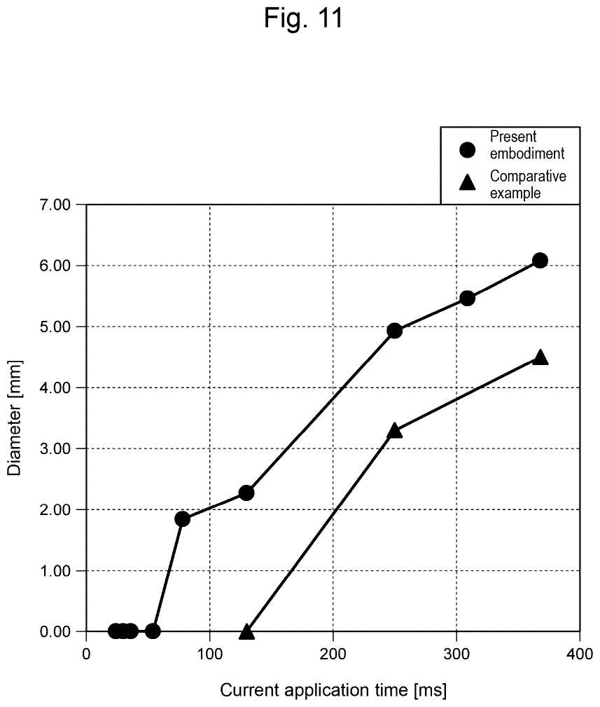

With reference to FIG. 9 to FIG. 11, described is a result of applying the current application pattern of the present embodiment to a welding target, that is, the plurality of steel plates including the shim S placed between the first steel plate W1 and the second steel plate W2. FIG. 9 is a cross-sectional diagram schematically illustrating a state where a plurality of steel plates having a different aspect from FIG. 2 is sandwiched between the pair of electrodes 4, 5. FIG. 10 is a diagram illustrating transition of the alloy layer diameter D1 and the nugget diameter D2 of the alloy layer A and the nugget N generated in the boundary portion between the first steel plate W1 and the second steel plate W2 illustrated in FIG. 9. FIG. 11 is a diagram illustrating transition of the nugget diameter D2 of the nugget N generated in the boundary portion between the second steel plate W2 and the third steel plate W3 illustrated in FIG. 9.

As illustrated in FIG. 10, even when the shim S is placed between the first steel plate W1 and the second steel plate W2, the current application pattern of the present embodiment can efficiently generate the alloy layer A and the nugget N while reducing the occurrence of spatter in the first period of the preliminary current application. In addition, the current application pattern of the present embodiment can maximize the amount of heat input to the welding portion at the spatter limit current value to allow the alloy layer A and the nugget N to efficiently grow while suppressing the rapid increase in the temperature of the welding portion to reduce the occurrence of spatter in the second period of the preliminary current application and the main current application period. Further, as illustrated in FIG. 11, it is found that even when the shim S is placed between the first steel plate W1 and the second steel plate W2, the current application pattern of the present embodiment can generate the nugget N that is larger than that of the comparative example not only in the boundary portion with a plate gap, but also in the boundary portion without a plate gap.

Note that in the above description, by way of example, the case of placing the shim S between the first steel plate W1 and the second steel plate W2 or placing the shim S between the second steel plate W2 and the third steel plate W3 has been described. However, the resistance spot welding method of the present embodiment may also be applied when the shim S is placed between the first steel plate W1 and the second steel plate W2 and also the shim S is placed between the second steel plate W2 and the third steel plate W3. That is, the resistance spot welding method of the present embodiment may be applied even when there is a plate gap in all of the boundary portions between the adjacent steel plates.

In addition, in the above description, by way of example, the welding target being the stack of steel plates obtained by placing on top of one another at least two steel plates including a plating layer of zinc as a main component has been described. However, the resistance spot welding method of the present embodiment may also be applied when the welding target is a stack of steel plates obtained by placing on top of one another at least two steel plates including an Al—Si plating layer. In addition, the resistance spot welding method of the present embodiment may also be applied when the welding target is a stack of steel plates obtained by placing on top of one another at least two steel plates having a zinc oxide layer as a surface layer.

As described above, the resistance spot welding method of the present embodiment is a resistance spot welding method including: placing on top of one another at least two steel plates including a plating layer of zinc as a main component or an Al—Si plating layer; sandwiching the at least two steel plates between a pair of electrodes; and performing preliminary current application between the pair of electrodes and then performing main current application, such that the steel plates that are adjacent to each other are melted and joined together. The resistance spot welding method of the present embodiment performs the preliminary current application so as to include a current application pattern in which a current value of a welding current at a current application start time of the preliminary current application is set as a maximum value, and the current value sequentially decreases stepwise from the maximum value along with a lapse of a current application time from the current application start time.

As described above, the resistance spot welding method of the present embodiment allows the welding current of the maximum current value to flow at the current application start time of the preliminary current application, at which time the steel plates are rigid, and the contact area between the steel plates and the pair of electrodes and the contact area between the adjacent steel plates are small. This can increase the temperature of the welding portion in a short time at the current application start time of the preliminary current application. In addition, the resistance spot welding method of the present embodiment finely controls the current value such that the current value of the welding current sequentially decreases stepwise from the maximum value. This can efficiently generate the alloy layer A and the nugget N at an early stage of the preliminary current application while efficiently increasing the temperature of the welding portion, and can reduce the occurrence of spatter by expanding the nugget diameter D2 according to the expansion of the alloy layer diameter D1. Accordingly, the resistance spot welding method of the present embodiment can efficiently generate the nugget N that is as large as possible while reducing the occurrence of spatter.

Further, in the resistance spot welding method of the present embodiment, the stepwise current application pattern employed in the first period of the preliminary current application is composed of multiple combinations of the current value and the current application time for the current value. Each of the combination of the current value and the current application time for the current value forming the stepwise current application pattern is a combination of an upper limit current value that can reduce occurrence of spatter and an upper limit current application time that can reduce occurrence of spatter during current application of the upper limit current value.

Accordingly, the resistance spot welding method of the present embodiment can efficiently generate the alloy layer A and the nugget N at an early stage of the preliminary current application while surely reducing the occurrence of spatter. Thus, the resistance spot welding method of the present embodiment can efficiently generate the nugget N that is as large as possible while surely reducing the occurrence of spatter.

Further, in the resistance spot welding method of the present embodiment, through the preliminary current application, the nugget N is generated in a boundary portion between the steel plates that are adjacent to each other and also the alloy layer A surrounding the nugget N is generated, the alloy layer A being made of a material of the plating layer and a material of a base material of the steel plates. Each of the combinations of the stepwise current application pattern is a combination in which the ratio (D1/D2) of the outer dimension of the alloy layer A (the alloy layer diameter D) to the outer dimension of the nugget N (the nugget diameter D2) in a direction along the steel plates has a reference value in a range of 1.2 to 1.5.

Accordingly, the resistance spot welding method of the present embodiment can surely achieve the reduction of the occurrence of spatter and the efficient generation of the nugget N at the same time. Thus, the resistance spot welding method of the present embodiment can surely efficiently generate the nugget N that is as large as possible while surely reducing the occurrence of spatter.

Further, in the resistance spot welding method of the present embodiment, a preliminary current application period in which the preliminary current application is performed includes a first period starting from the current application start time and a second period starting after the first period, and the current application pattern of the preliminary current application in the first period is the above-described stepwise current application pattern, and the current application pattern of the preliminary current application in the second period is an upslope current application pattern in which the current value gradually increases from the current value at the first period end time along with a lapse of the current application time.

Accordingly, the resistance spot welding method of the present embodiment can allow the alloy layer A and the nugget N to efficiently grow while suppressing the rapid increase in the temperature of the welding portion to reduce the occurrence of spatter in the second period of the preliminary current application. Thus, the resistance spot welding method of the present embodiment can efficiently generate the nugget N that is as large as possible while further reducing the occurrence of spatter.

Further, in the resistance spot welding method of the present embodiment, the current application pattern of the main current application is a current application pattern in which the current value at a time when the preliminary current application ends is maintained constant from the time when the preliminary current application ends to a time when the main current application ends.

Accordingly, the resistance spot welding method of the present embodiment can allow the alloy layer A and the nugget N to efficiently grow while suppressing the rapid increase in the temperature of the welding portion to reduce the occurrence of spatter in the main current application period. Thus, the resistance spot welding method of the present embodiment can efficiently generate the nugget N that is as large as possible while further reducing the occurrence of spatter.

Although the embodiments of the present disclosure have been described in detail above, the present disclosure is not limited to the above embodiments, and various changes are possible in so far as they are within the spirit of the present disclosure in the scope of the claims. In the present disclosure, it is possible to add, to a configuration of an embodiment, a configuration of another embodiment, to replace a configuration of an embodiment with a configuration of another embodiment, or to delete a part of a configuration of an embodiment.

### REFERENCE SIGNS LIST

1 Resistance spot welding device
2 Welding gun
3 Robot arm
4 Upper electrode
5 Lower electrode
6 Elevator
7 Position detecting device
8 Current adjusting device
9 Control device
A Alloy layer
D1 Alloy layer diameter
D2 Nugget diameter
G Gap
N Nugget
S Shim
T0 to T3 Point in time
W1 First steel plate
W2 Second steel plate
W3 Third steel plate

1. A resistance spot welding method, comprising:
placing on top of one another at least two steel plates including a plating layer of zinc as a main component or an Al—Si plating layer;
sandwiching the at least two steel plates between a pair of electrodes; and
performing preliminary current application between the pair of electrodes and then performing main current application, such that the steel plates that are adjacent to each other are melted and joined together,
wherein the preliminary current application is performed so as to include a current application pattern in which a current value of a welding current at a current application start time of the preliminary current application is set as a maximum value, and the current value sequentially decreases stepwise from the maximum value along with a lapse of a current application time from the current application start time.

2. The resistance spot welding method according to claim 1,
wherein
the stepwise current application pattern is composed of multiple combinations of the current value and the current application time for the current value, and
each of the combinations of the current value and the current application time for the current value forming the stepwise current application pattern is a combination of an upper limit current value that can reduce occurrence of spatter and an upper limit current application time that can reduce occurrence of spatter during current application of the upper limit current value.

3. The resistance spot welding method according to claim 2,
wherein
through the preliminary current application, a nugget is generated in a boundary portion between the steel plates that are adjacent to each other and also an alloy layer surrounding the nugget is generated, the alloy layer being made of a material of the plating layer and a material of a base material of the steel plates, and
each of the combinations of the stepwise current application pattern is a combination in which a ratio of an outer dimension of the alloy layer to an outer dimension of the nugget in a direction along the steel plates has a reference value in a range of 1.2 to 1.5.

4. The resistance spot welding method according to claim 1,
wherein
a preliminary current application period in which the preliminary current application is performed includes a first period starting from the current application start time and a second period starting after the first period,
the current application pattern of the preliminary current application in the first period is the stepwise current application pattern, and
the current application pattern of the preliminary current application in the second period is an upslope current application pattern in which the current value gradually increases from the current value at the first period end time along with a lapse of the current application time.

5. The resistance spot welding method according to claim 1, wherein the current application pattern of the main current application is a current application pattern in which the current value at a time when the preliminary current application ends is maintained constant from the time when the preliminary current application ends to a time when the main current application ends.
